(19) United States
(12) Patent Application Publication
(10) Pub. No.: US 2006/0091630 A1
(43) Pub. Date: May 4, 2006

(54) Racing sulky

(76) Inventors: Ron Goddard, Lasalle (CA); Marc-Andre Octeau, Montreal (CA); Larry Lessard, Montreal (CA); Eric St-Amant, Repentigny (CA)

Correspondence Address: Franz Bonsang;c/o PROTECTIONS EQUINOX INT'L INC., Suite 224, 4480, Cote-de-Liesse, Montreal, QC, H4N 2R1, CA

(21) Appl. No.: 11/181,932

(22) Filed: Jul. 15, 2005

Related U.S. Application Data
(60) Provisional application No. 60/623,227, filed on Nov. 1, 2004.

(51) Int. Cl. B62C 1/00

(52) U.S. Cl. 280/63

(57) ABSTRACT

A racing sulky is provided with wheel mounting forks that are angularly orientated rearwardly away from the shafts to locate the wheel axis rearward of the center of mass of the sulky, the angular orientation lying in the range 1° to 40°. A seat mounted on the sulky rearward of the sulky center of mass and the wheel axis allow the center of mass of a rider to substantially balance the sulky center of mass. A corresponding sulky harness connector is also disclosed.

### CROSS REFERENCE TO RELATED APPLICATIONS

Benefit of U.S. Provisional Application for Patent Ser. No. 60/623,227, filed on Nov. 1, 2004, is hereby claimed.

### FIELD OF THE INVENTION

The present invention concerns racing sulkies, more particularly to a balanced racing sulky for use with a racehorse.

### BACKGROUND OF THE INVENTION

Lameness represents one of the greatest threats to the health and racing careers of racehorses and is particularly relevant with Standardbreds that are used in harness racing. Harness racing involves connecting a sulky, or bike, to the racehorse, which is driven by a rider sitting rearwardly of the sulky. The sulky typically includes a frame, two wheels, a seat for the rider and two elongate shafts for connecting to a horse harness on either side of the horse. The rider sits on the seat and controls the horse using reins. In harness racing, a generally oval racetrack is used, which is banked upwards and away from the center. During a race, the workload performed by the horse includes transport of its own mass against air resistance, the track surface, centrifugal forces as well as the sulky and rider's mass. The rider's center of mass is typically located behind the wheel axles, which causes the sulky to lift upwardly at the sulky shafts and hinder the horse's natural running gait. Moreover, the horse's natural running gait causes the horse's sides lateral torso to move up and down during full forward and rearward limb extensions, with the force of this action being transferred to the sulky wheels via the harness connector and the sulky frame thereby causing the sulky wheels to oscillate left and right with a yaw rotation. The aforesaid factors combine to decrease the efficiency of the horse's running form, which in turn can significantly reduce the speed and comfort of the horse. Moreover, current sulky designs and the track's banking combine to cause upper body and lower leg injuries to the horse. This may significantly reduce the racing career of the horse and cause costly veterinarian bills.

Many designs of sulkies exist, a few examples of which are as follows:
U.S. Pat. No. 4,326,367, issued Apr. 27, 1982 to Cashman for “Racing Sulky and Harness”; and
Published PCT application WO 93/19969, published Oct. 14, 1993 to Walsh for “Horse Drawn Sulky”.

The aforesaid designs suffer from a number of important drawbacks. Disadvantageously, Walsh's design requires that the forks be connected to moveable forks, which appears to require that the rider adjust the position of the axles before racing. Walsh's design may not be suitable for positioning the axles rearwardly of the sulky frame. In Cashman's design, the sulky's orientation relative to the ground and to the horse may cause significant discomfort to the horse and may not provide the horse with sufficient flexibility to enable unhindered running movement. Furthermore, there does not appear to be sufficient flexibility in the harness system to allow the horse's movements to be independent of the sulky shafts. In addition, many sulkies have significant stress forces placed on the frames during races due to the design of the sulky and sulky connectors.

Thus there is a need for an improved racing sulky.

### SUMMARY OF THE INVENTION

The present invention reduces the difficulties and disadvantages of the prior art by providing a balanced racing sulky that allows a racehorse harnessed thereto to reach and maintain maximum speed with a significantly more natural gait. To achieve this, the inventor has unexpectedly discovered that angling two straight wheel-bearing forks rearwardly away from the rear end of the horse locates the rider's center of mass behind the axles without causing the sulky shafts to lift. Advantageously, this arrangement balances the sulky and significantly reduces the workload placed on the horse during a race. Moreover, this arrangement increases the horse's athletic performance and significantly reduces injuries to the horse's upper body and lower legs. In addition, an adjustable seat and foot stirrups are connected to the sulky frame to allow the sulky to be custom fit to compensate for differences in rider height and weight, while maintaining balance.

Additionally, the sulky horse harness connector of the present invention connecting the sulky arms to the horse harness significantly reduces harmful efforts imparted on the racehorse from the movement of the sulky that could induce injuries to the horse, to increase the horse comfort and speed during race, especially because of the connector design and dynamic self adjustments and impact dampers.

In accordance with an object of the present invention, there is provided a racing sulky for use with a racehorse, comprising: a pair of forks connected to a cross bar at a rear portion of a racing sulky frame connectable to the racehorse, the cross bar being adjacent a center of mass of the sulky, the forks having respectively two wheels rotatably mounted thereon and the forks being angled rearwardly of the sulky so as to located a wheel axis rearward of the sulky center of mass.

In one embodiment, the racing sulky further includes a rider seat connected to the sulky frame and located rearward from the cross bar and rearward from the wheel axis so as to have a center of mass of the rider substantially balancing the sulky center of mass.

Typically, the rider seat is movably connected to the sulky frame so as to have the seat longitudinally adjustably positioned relative to the sulky frame, whereby different weight riders can substantially balancingly ride the sulky.

Conveniently, the forks are angled rearwardly away from a generally vertical axis at an angle lying in the range of about one to forty degrees (1° to 40°); and preferably at about twenty degrees (20°).

Conveniently, the forks are connected to the rear portion of the sulky frame such that they are cambered downwardly away at an angle lying in the range of about one half to five degrees (0.5° to 5°) from a vertical plane perpendicular to the cross bar; and preferably about two degrees (2°).

In accordance with another object of the present invention, there is provided a sulky harness connector for mounting on a front portion of a racing sulky, the harness connector comprising a frame adapted for connection to a horse harness, a body and two shafts, the frame including an upper end portion and a lower end portion, the shafts being connected to and extending between the upper and lower end portions and providing a limited path of travel for the frame relative to the body.

In one embodiment, the body includes a shaft mounting portion, a sulky shaft receiver portion and a latch receiver portion.

Typically, the shaft mounting portion is located on a sidewall of the body and faces the frame, the shaft mounting portion further comprising a generally rectangular housing having a horizontal top sidewall, a horizontal bottom sidewall, a first vertical sidewall and second vertical sidewall, the sidewalls defining an interior space, the top and bottom sidewalls having bores for slidably accommodating the shafts, and a resilient biasing means is provided on at least one of the shafts on either side of the top and the bottom sidewalls for biasing the body generally centrally between the upper and lower end portions of the frame.

Conveniently, the sulky shaft receiver portion defines a socket of generally cylindrical form, the socket forming a concave recess and being relieved to allow access of an end of a sulky shaft connector, and the sulky shaft connector having a spherical end for engagement with the said recess of the socket.

Typically, the latch receiver portion is contiguous with the shaft receiver portion and is formed of a box-like structure through which a latch passes from the outside thereof into the recess of the shaft receiver section, the latch being resiliently biased into and being arranged in one locking position to extend across the recess in the shaft receiver portion thereby in use to retain the spherical end of the sulky shaft connector within the shaft receiver portion.

Conveniently, the sulky shaft connector includes a member formed such as to slide into a lumen formed within the end of a sulky shaft.

Conveniently, the sulky shaft connector member comprises an elongate shaft, a head member, a base member and a biasing member, the head member and the base member being movably mounted on the elongate shaft and biased apart from each other by the biasing member.

Typically, the head member includes a cylindrical body provided with an axial bore sized to slide over the elongate shaft, the cylindrical body having an outer sidewall provided with a sulky shaft abutment portion and a sulky shaft insertion portion sized and shaped to be locked into the lumen formed in the end of the sulky shaft.

Conveniently, the base member of the connector member includes a disc member having disc member hole means sized to allow the elongate shaft to slide therethrough, a pair of separator members is connected to the disc member and to a lower end of the cylindrical body, the separator members being axially aligned with the elongate shaft and running parallel alongside the elongate shaft, a guide disc is fixedly mounted on the elongate shaft and is located between the head member and the base member.

Conveniently, the guide disc has two radially disposed guide grooves adapted to slidingly and axially cooperate with the two separator members.

Typically, the biasing member includes a pair of resilient biasing means provided either side of the guide disc for biasing the guide disc, preferably generally centrally, between the head member and the base member; and the biasing member preferably comprises an open coil compression spring.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, in which:

FIG. 1 is a simplified side elevation view of a racing sulky of the present invention harnessed to a racehorse;

FIG. 2 is a simplified perspective exploded view of the sulky, a sulky shaft connector and a harness connector;

FIG. 3 is a perspective view of the harness connector connected to the sulky shaft connector;

FIG. 4 is a top plan view of FIG. 3;

FIG. 5 is a side view the harness connector; and

FIG. 6 is an exploded view of the harness connector and sulky shaft connector.

### DETAILED DESCRIPTION OF THE PREFERRED EMBODIMENTS

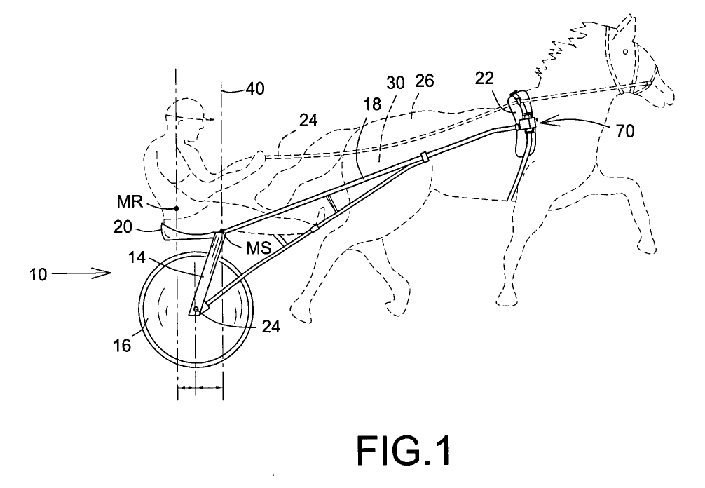

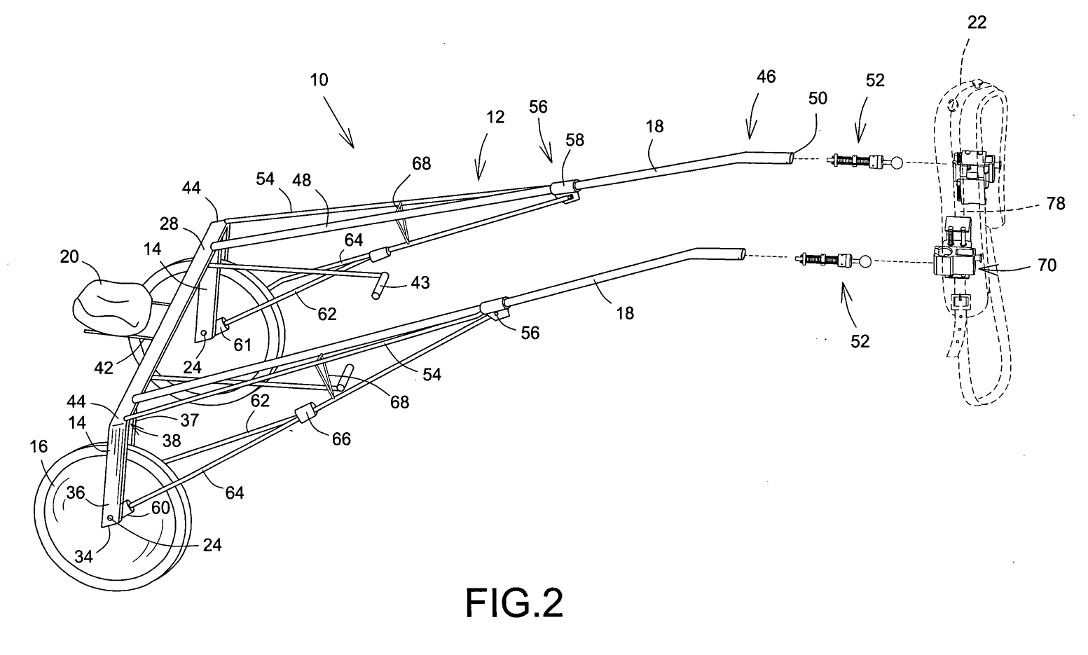

Referring now to FIGS. 1 and 2, an embodiment of a racing sulky is shown generally at 10. Broadly speaking, the sulky 10 includes a frame 12, a pair of forks 14, a pair of wheels 16, two elongate sulky shafts 18 and a seat 20. A harness 22 and reins 24 respectively provide a means of connecting the sulky 10 to a horse 26 and controlling the horse 26.

The frame 12 includes a rear cross connector bar 28 to which the two forks 14 are connected. Typically, the forks 14 are welded to the cross connector bar 28, but maybe part of a single piece of material which is machined and formed into the two forks 14. In accordance with the present invention, the forks 14 are angled away from the rear end 30 of the horse 26 and locate the center of mass MS of the sulky 10 generally located adjacent the cross connector bar 28 in front of the wheel's axles 24 so as to substantially statically balance a rider's center of mass MR behind the wheel's axles 24 when harnessed to the horse 26. Since both forks 14 are essentially identical, only one will be described in detail. The fork 14 includes two spaced apart struts 36, 37 that form a gap 38 of sufficient width to allow the wheel 16 to be mounted therebetween on the axle 24. The wheel 16 is connected to a lower end 34 of the struts 36, 37 using conventional fasteners. Preferably, the forks 14 are angled away from a generally vertical y-axis 40 at an angle of from about one to about forty degrees (1° to 40°). More preferably, the forks 14 are angled away from the y-axis 40 at about twenty degrees (20°). The fork 14 is made from a straight, generally elongate rectangular piece of substantially rigid, non-resilient material, such as steel and the like.

For greater wheel tracking and cornering around a banked racetrack, the forks 14 are also connected to the cross connector bar 28 such that they are cambered downwardly away from the frame 12 at from about one half to about five degrees (0.5° to 5°), more typically at about two degrees (2°) from the y-axis 40 or a vertical plane perpendicular to the cross bar 28 when viewed from the sulky rear.

As best illustrated in FIG. 2, the seat 20 is connected to the cross connector bar 28 and typically is adjustably mounted on two seat support shafts 42 which allow the seat 20 to be adjusted towards or away from the rear end of the horse 26 depending upon the weight of the rider to essentially balance the center of mass of the sulky 10. Conventional adjustment means (not shown) known to those skilled in the art are typically used. A pair of footrests or stirrups 43 are connected to the cross connector bar 28 are generally orthogonal relative thereto against which the rider rests his heels during operation of the sulky 10. The stirrups 43 may be adjusted to conform to the rider's height.

The two elongate sulky shafts 18 are spaced apart and connected to the end portions 44 of the cross connector bar 28. Each sulky shaft 18 is angled inwardly towards the sides of the horse 26 so that they may be connected to the harness 22 as will be described in more detail below. Since each sulky shaft 18 is essentially identical, only one will now be described in detail.

As seen in FIG. 2, the sulky shaft 18, are typically of tubular construction and include a front portion 46 and a rear portion 48. The front portion 46 includes a lumen 50 sized to slidably receive therein a sulky shaft connector 52. The front portion 46 is angled such that when the sulky 10 is harnessed, the front portion 46 lies generally parallel to the ground. The rear portion 48 may be connected to the cross connector bar 28 by welding or may be of a unitary construction. The sulky shaft 18 is angled upwardly away from the ground to enable the correct racing form to be achieved once the sulky 10 is connected to the harness 22.

A pair of stabilizer bars 54 are connected to the cross connector bar 28 and are located outside of the sulky shaft rear portions 48. Each stabilizer bar 54 is angled towards a connector point 56 located on the sulky shafts 18. A connector collar 58 connects the stabilizer bars 54 to their respective sulky shafts 18 in a triangular configuration.

Each of the lower end 34 of the struts 36, 37 is typically machined to be angled away from the ground and includes a strut connector 60, 61 to which an inner wheel stabilizer shaft 62 and an outer wheel stabilizer shaft 64 are respectively connected. The outer wheel stabilizer shaft 64 extends from the lower end 34 of the strut 36 and is connected to the sulky shaft 18 at the connector collar 58. The outer wheel stabilizer shaft 64 is angled inwardly to connect with the connector collar 58. The inner wheel stabilizer shaft 62 extends from the lower end 34 of the struts 37 and is connected to the outer wheel stabilizer shaft 64 at a connector sleeve 66.

Two triangular shaped connector pieces 68 interconnect the sulky shaft 18, the stabilizer bar 54 and the outer wheel stabilizer shaft 64 and strengthen the sulky 10 and minimizes vertical and lateral movements of the sulky 10 during operation.

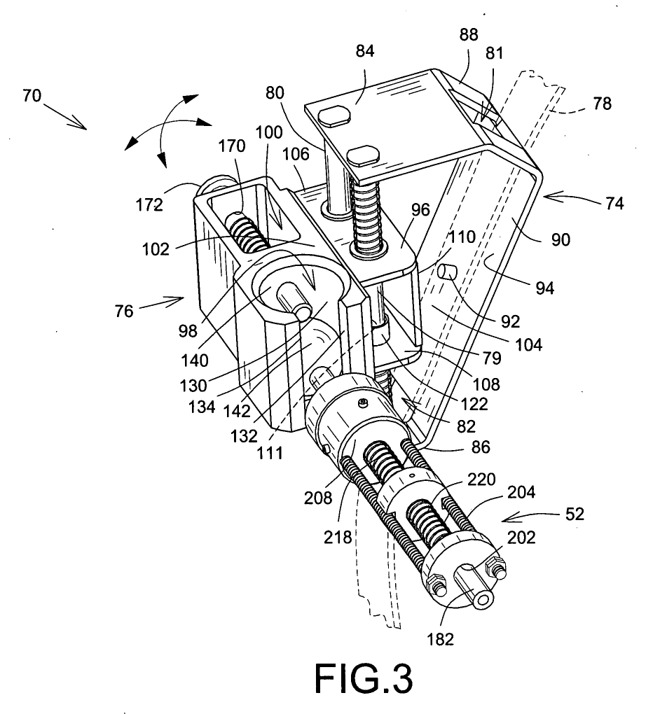

Referring now to FIGS. 3, 4, 5 and 6, a harness connector 70 is used together with the sulky shaft connector 52 to enable the sulky 10 to be connected to the horse 26. Since two harness connectors 70 are used on either side of the horse 26 and are essentially identical, only one will be described in detail. Broadly speaking, the harness connector 70 includes a frame 74, a body 76 and two shafts 79, 80. One skilled in the art will readily understand that while two shafts are illustrated in this embodiment, one will suffice without deviating from the scope of their invention.

The frame 74 is connected to the harness 22 using a strap 78. The frame 74 includes two belt connector members 81, 82, although one skilled in the art will recognize that the strap 78 could be connected to the frame 74 at least one connector member without deviating from the scope of the present invention. Moreover, one skilled in the art will also recognize that many different types of strap connector are available and may be used with the frame 74 without deviating from the scope of the present invention.

The frame 74 includes an upper end portion 84 and a lower end portion 86 that are axially spaced apart. The end portions 84, 86 are generally flat plate portions that are generally parallel to each other. The frame 74 also includes an short angled intermediate portion 88 and a long angled intermediate portion 90, both of which angle away from the two flat end portions 84, 86 towards the horse's side. Typically, the upper end portion 84 is wider than the lower end portion 86. A projection 92 extends from an outwardly disposed frame surface 94 for stabilizing the strap 78 once the strap 78 is connected to the frame 74.

The two shafts 79, 80 are connected between the upper end portion 84 and the lower end portion 86 and are spaced apart from each other and generally parallel. The shafts 79, 80 are connected to their respective flat plates using conventional fasteners such as bolts and the like. One skilled in the art will understand that the shafts 79, 80 and the frame 74 may also be a unitary body machined from a single piece of material, without deviating from the scope of the present invention. The two shafts 79, 80 between the upper end portion 84 and the lower end portion 86 define a limited path of travel for the frame 74 to move relative to the body 76. One skilled in the art will also recognize that the body 76 may also move along the path of travel between the upper end portion 84 and the lower end portion 86.

The body 76 includes a shaft mounting portion 96, a sulky shaft receiver portion 98 and a latch receiver portion 100. The shaft mounting portion 96 is located on a body sidewall 102 and faces the frame surface 94. The shaft mounting portion 96 includes a generally rectangular housing 104 having a horizontal top sidewall 106, a horizontal bottom sidewall 108, a first vertical sidewall 110 and a second vertical sidewall 111. The sidewalls 106, 108, 110, and 111 define an interior space 112. The sidewalls 106 and 108 each have apart bores 114, 116, 118 and 120 located therein. The bores 114, 116, 118, and 120 are of sufficient dimension to allow the two shafts 78, 80 to be slidably mounted thereon. One skilled in the art will recognize that the rectangular housing 104 may also be a solid piece having a single bore located therein without deviating from the scope of the invention to allow one shaft unhindered movement therethrough. Preferably, each of the bores 114, 116, 118 and 120 includes a bushing 122 that surround the shafts 79, 80 and allows unhindered movement though the bores 114, 116, 118 and 120. The bushing 122 may be made of a material that reduces friction between the shafts 79, 80 and the bores. Examples of such material include, but are not limited to, brass and FREELON™.

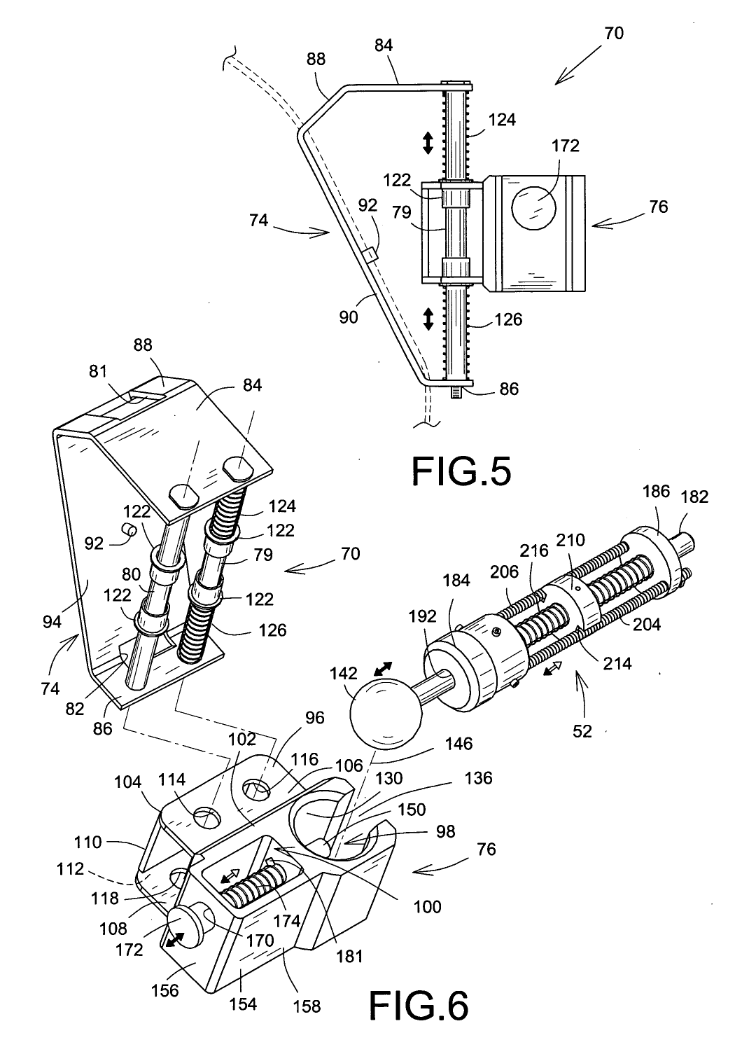

As best illustrated in FIGS. 5 and 6, two compression springs 124, 126 are mounted on the shaft 79. The upper compression spring 124 is located between the upper end portion 84 of the frame 74 and the horizontal top sidewall 106 of the housing 104, whereas the lower compression spring 126 is located between the lower end portion 86 of the frame 74 and the horizontal bottom wall sidewall 108 of the housing 104. The springs 124, 126 bias and center the body 76 between the two spaced apart upper and lower end portions 84, 86 of the frame 74. This enables the upper and lower end portions 84, 86 of the frame 74, which is connected directly to the horse harness 22, as shown in FIG. 5, to move independently of the body 76 and relative thereto, along, a generally vertical path of travel. Since the identical arrangement is found on both sides of the horse, the independent movement and cushioning effect of the both harness connectors 70 compensates for the up and down movement of the horse's sides during the normal running gait and also compensates for the differences in horse's body positioning when the horse is cornering around the banked track. The harness connector 70 also compensates for increased banking in turns, typically about twelve degrees (12°), while allowing the front portion of the outer sulky shafts, located towards the outer track portion, to rise in direct proportion to the outer wheel, which is raised to a position higher than the inner wheel, which is located towards the inner track portion. While an independent spring and shaft cushioning or suspension system is illustrated, one skilled in the art will readily understand that other independent cushioning or suspension systems may also be employed without deviating from the scope of the invention. Examples of other cushioning or suspension systems include, but are not limited, to hydraulic systems and gas dampers and the like.

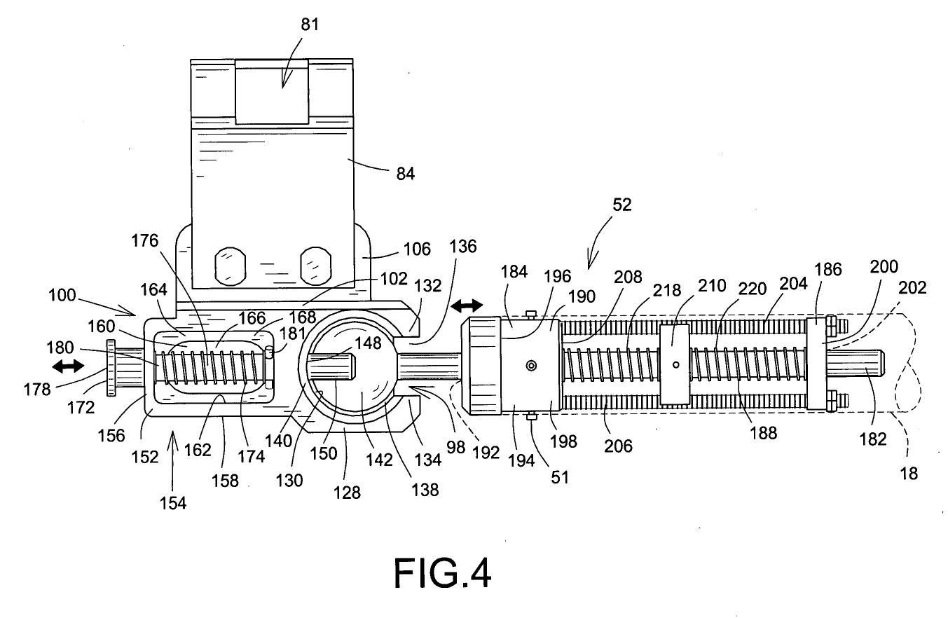

As best illustrated in FIGS. 3 and 4, the sulky shaft receiver portion 98 is located in a proximal body portion 128. The sulky shaft receiver portion 98 is a socket and includes a generally cylindrical sidewall 130, having two spaced apart sidewall ends 132, 134 that define a gap 136 or a channel there between, and a lower sidewall 138 that closes off the lower end of the cylindrical sidewall 130. The cylindrical sidewall 130 and the lower sidewall 138 define a concave recess 140, which is sized and shaped to receive a ball end 142 of the sulky shaft connector 52 therein. The concave recess 140 has a recess axis 146, which is generally parallel to the shafts 79, 80. A first latch end hole 148 is located in the cylindrical sidewall 130 and is positioned such that a first latch end 150 projects sufficiently through the hole 148 to capture the ball end 142 and to limit vertical movement of the ball end 142.

The latch receiver portion 100 is located in a distal body portion 152 and includes a latch housing 154. The latch housing 154 includes a first latch housing sidewall 156 and a second latch housing sidewall 158. The latch housing sidewalls 156, 158 are interconnected to the cylindrical sidewall 130 and to the second vertical sidewall 112 of the rectangular housing 104 and define a latch housing opening 160. An inner latch housing sidewall 162 divides the latch housing opening 160 into a wide upper portion 164 and a narrow lower portion 166, which terminates in a ledge portion 168. The second latch housing sidewall 158 includes a second latch end hole 170 axially aligned with the first latch end hole 148. A spring loaded latch 172 is slidably mounted in the first and second latch end holes 148, 170 and is biased towards the sulky shaft receiver portion 98 by a biasing spring 174 that is located on a central latch shaft portion 176 between the second latch housing sidewall 158 and the cylindrical sidewall 130. A first stop member 178 is connected to a second latch end 180 and is shaped to allow an operator to pull the latch 172 away from the ball end 142 to disengage the harness connector 70 from the sulky shaft connector 52. The first stop member 178 is sized and shaped to be larger than the second latch end hole 170 so that it abuts the second latch housing sidewall 158 when the latch 172 is biased towards the ball end 142. A second stop member 181 is located between the end of the biasing spring 174 and the cylindrical sidewall 130 and abuts the portion of the cylindrical sidewall 130, which faces the latch housing opening 160. In this embodiment, the second stop member 181 is a bar located generally orthogonal to the latch shaft. One skilled in the art will recognize that although a spring loaded latch is described, other types of latching mechanisms may be employed to hold the sulky shaft connector in position, without deviating from the scope of the invention.

Since two sulky shaft connectors 52 are normally used together with two of the harness connectors 70 and are essentially identical, only one will be described in detail. Referring now to FIGS. 3, 4, and 6, the sulky shaft connector 52 includes an elongate shaft 182 with the ball end 142 connected to a shaft distal end, a head member 184, a base member 186 and a biasing member 188. The head member 184 and the base member 186 are both movably mounted on the elongate shaft 182 and biased apart from each other by the biasing member 188.

The head member 184 includes a generally cylindrical body 190 that has an axial bore 192 sized to slide over the elongate shaft 182. The cylindrical body 190 includes an outer sidewall 194 that has a sulky shaft abutment portion 196 and a sulky shaft insertion portion 198, which is sized and shaped to be locked into the sulky shaft lumen 50 (see FIG. 2) after the insertion portion 198 slides into the lumen 50. A number of screws 51 are typically used to secure the head member 184 into the sulky shaft lumen 50.

The base member 186 includes a disc member 200 having a disc member hole 202 located central thereof and sized to allow the elongate shaft 182 to slide therethrough. A pair of separator members 204, 206 are connected to the disc member 200 and to a lower end 208 of the cylindrical body 190. The separator members 204, 206 are axially aligned with the elongate shaft 182 and run parallel alongside the elongate shaft 182. A guide disc 210 is fixedly mounted on the elongate shaft 182 and is located between the head member 184 and the base member 186. The guide disc 210 includes two radially disposed guide grooves 214, 216, which are sized and shaped to slidingly cooperate with the two separator members 204, 206.

The biasing member 188 includes a first compression spring 218 and a second compression spring 220. The first compression spring 218 is located between the lower end 208 of the cylindrical body 190 and the guide disc 210. The second compression spring 220 is located between the guide disc 210 and the base member 186. Once the head member 184 is connected into the sulky shaft lumen 50, the compression springs 218, 220 bias apart the head member 184 and the base member 186 and only allow the guide disc 210 to move relative to the head member when the elongate shaft 182 extends and retracts relative to the head member, depending upon the forces applied thereto. The guide disc 210 also prevents the elongate shaft 182 from disengaging from the head member 184 and the base member 186 by abutting against the head member 184 and stopping the elongate shaft member 182.

Operation

Referring now to FIGS. 1, 2, and 3, a typical operation of the sulky 10 will now be described beginning with the sulky 10 disassembled from the harness 22. The rider pulls back on the spring loaded latch 172 and inserts the ball end 142 of the sulky shaft connector 52 down into the sulky shaft receiver portion 98 in a ball and socket configuration. The portion of the elongate shaft 182, which extends away from the head member 184, loosely engages the gap 136 between the two spaced apart sidewall ends 132, 134. The rider then releases the latch 172 to lock the ball end 142 into the shaft receiver portion 98. This ball and socket arrangement enables multidirectional pivotal movement of the harness connector 70 relative to the sulky shaft (as illustrated by the arrows in FIG. 3), which compensates for the horse's movements during racing and significantly reduces or essentially eliminates sulky shaft lateral movement.

Once assembled, the rider, if desired adjusts the seat 20 and mounts the sulky 10. During racing, the harness connectors 70 and the sulky shaft connectors 52, located on each side of the horse, operate as independent suspension and cushioning systems that allow independent extension and retraction of the sulky shafts' length during cornering and also independently compensates for the differences in turning radius between the inner wheels, closest to the track's center, and the outer wheels, located on the banked portion of the track.

While a specific embodiment has been described, those skilled in the art will recognize many alterations that could be made within the spirit of the invention, which is defined solely according to the following claims.

We claim:

1. A racing sulky for use with a racehorse, comprising: a pair of forks connected to a cross bar at a rear portion of a racing sulky frame connectable to the racehorse, the cross bar being adjacent a center of mass of the sulky, the forks having respectively two wheels rotatably mounted thereon and the forks being angled rearwardly of the sulky so as to located a wheel axis rearward of the sulky center of mass.

2. The racing sulky of claim 1 further including a rider seat connected to the sulky frame and located rearward from the cross bar and rearward from the wheel axis so as to have a center of mass of the rider substantially balancing the sulky center of mass.

3. The racing sulky of claim 2 wherein the rider seat is movably connected to the sulky frame so as to have the seat longitudinally adjustably positioned relative to the sulky frame, whereby different weight riders can substantially balancingly ride the sulky.

4. The racing sulky of claim 1 wherein the forks are angled rearwardly away from a generally vertical axis at an angle lying in the range of about one to forty degrees (1° to 40°).

5. The racing sulky of claim 4 wherein the angular orientation of the forks in the rearwards direction is about twenty degrees (20°).

6. The racing sulky of claim 1 wherein the forks are connected to the rear portion of the sulky frame such that they are cambered downwardly away at an angle lying in the range of about one half to five degrees (0.5° to 5°) from a vertical plane perpendicular to the cross bar.

7. The racing sulky of claim 6 wherein the camber angle is approximately two degrees (2°).

8. A sulky harness connector for mounting on a front portion of a racing sulky, the harness connector comprising a frame adapted for connection to a horse harness, a body and two shafts, the frame including an upper end portion and a lower end portion, the shafts being connected to and extending between the upper and lower end portions and providing a limited path of travel for the frame relative to the body.

9. The harness connector of claim 8 wherein the body includes a shaft mounting portion, a sulky shaft receiver portion and a latch receiver portion.

10. The harness connector of claim 9 wherein the shaft mounting portion is located on a sidewall of the body and faces the frame, the shaft mounting portion further comprising a generally rectangular housing having a horizontal top sidewall, a horizontal bottom sidewall, a first vertical sidewall and second vertical sidewall, the sidewalls defining an interior space, the top and bottom sidewalls having bores for slidably accommodating the shafts, and a resilient biasing means is provided on at least one of the shafts on either side of the top and the bottom sidewalls for biasing the body generally centrally between the upper and lower end portions of the frame.

11. The harness connector of claim 9 wherein the sulky shaft receiver portion defines a socket of generally cylindrical form, the socket forming a concave recess and being relieved to allow access of an end of a sulky shaft connector, and the sulky shaft connector having a spherical end for engagement with the said recess of the socket.

12. The harness connector of claim 11 wherein the latch receiver portion is contiguous with the shaft receiver portion and is formed of a box-like structure through which a latch passes from the outside thereof into the recess of the shaft receiver section, the latch being resiliently biased into and being arranged in one locking position to extend across the recess in the shaft receiver portion thereby in use to retain the spherical end of the sulky shaft connector within the shaft receiver portion.

13. The harness connector of claim 11 wherein the sulky shaft connector includes a member formed such as to slide into a lumen formed within the end of a sulky shaft.

14. The harness connector of claim 13 wherein the sulky shaft connector member comprises an elongate shaft, a head member, a base member and a biasing member, the head member and the base member being movably mounted on the elongate shaft and biased apart from each other by the biasing member.

15. The harness connector of claim 14 wherein the head member includes a cylindrical body provided with an axial bore sized to slide over the elongate shaft, the cylindrical body having an outer sidewall provided with a sulky shaft abutment portion and a sulky shaft insertion portion sized and shaped to be locked into the lumen formed in the end of the sulky shaft.

16. The harness connector of claim 15 wherein the base member of the connector member includes a disc member having disc member hole means sized to allow the elongate shaft to slide therethrough, a pair of separator members is connected to the disc member and to a lower end of the cylindrical body, the separator members being axially aligned with the elongate shaft and running parallel alongside the elongate shaft, a guide disc is fixedly mounted on the elongate shaft and is located between the head member and the base member.

17. The harness connector of claim 16 wherein the guide disc has two radially disposed guide grooves adapted to slidingly and axially cooperate with the two separator members.

18. The harness connector of claim 14 wherein the biasing member includes a pair of resilient biasing means provided either side of the guide disc for biasing the guide disc between the head member and the base member.

19. The harness connector of claim 18 wherein the biasing member comprises an open coil compression spring.

20. The harness connector of claim 18 wherein the resilient biasing means are adapted to bias the guide disc generally centrally between the head member and the base member.
